(19) United States
(12) Patent Application Publication
(10) Pub. No.: US 2006/0258366 A1
(43) Pub. Date: Nov. 16, 2006

(54) Drilling method

(75) Inventors: Katsumi Oki, Kurokawa-gun (JP); Tsuyoshi Ueno, Yokosuka-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/548,973

(22) PCT Filed: Mar. 23, 2004
(86) PCT No.: PCT/JP04/03923

§ 371 Date: May 10, 2006

(30) Foreign Application Priority Data
Apr. 8, 2003 (JP) 2003-104093

(51) Int. Cl. H04Q 7/20

(52) U.S. Cl. 455/456.1

(57) ABSTRACT

A subject of the present invention is to provide a mobile terminal device capable of informing an appointed person of the information that the user of the mobile terminal device will be late for an appointment, irrespective of the user's situation. A mobile terminal device (100) includes a position sense portion (1) for measuring a present position, a communication portion (2) for transmitting/receiving an E-mail, a clock portion (3) for measuring a current time, an input portion (4) and a display portion (5) used when the user executes operations, and a control portion (6) for controlling an operation of the mobile terminal device (100). The user inputs appointed time, place, and person via the input portion (4), and then the control portion (6) sends the E-mail containing information of user's present position, or the like to the appointed person to inform automatically the appointed person of user's present position when user's present position sensed by the position sense portion (1) at the appointed time does not match with the appointed place.

### TECHNICAL FIELD

The present invention relates to a mobile terminal device such as a cellular phone device, a PHS (Personal Handy-phone System) terminal, or the like.

### BACKGROUND ART

Recently, the cellular phone device capable of utilizing position information obtained by the position sensing unit such as the GPS (Global Positioning System) receiver, or the like installed into there is coming into wide use. As the service utilizing the position information, there are known the system for sending a map showing user's present position by the E-mail to inform the other person of user's present place, and the like.

Also, there is known such a technology that the user sets a boarding station of a passenger train that the user boards to go to an appointed place, a riding time, and a getting-off station previously in the mobile terminal device, then the mobile terminal device calculates an arrival time of the passenger train at the getting-off station based on above set information and an operating schedule, and then the mobile terminal device sends a document indicating the effect that the running of the passenger train is delayed to an appointed person when the arrival time is different from an actual arrival time. According to this mobile terminal device, the user can inform automatically the appointed person of user's own current situation even though the user does not become aware of the delay of the train or the user cannot get into communication with the appointed person (see Patent Literature 1).

(Patent Literature 1) JP-A-2002-230461

However, in the mobile terminal device into which the position sensing unit such as the GPS receiver, or the like is installed, in order to inform the other person on the other end of user's present position when the user will be late for the appointment, the possessor of the mobile terminal device must execute complicated operations such that the possessor prepares a map showing possessor's present position and then sends the map to the appointed person by the E-mail. Often the user cannot operate the mobile terminal device on user's way to the appointed place, e.g., the user is driving the car, the user is boarding a packed train, or the like. In such case, the user cannot inform the other person on the other end of user's present position to cause the appointed person uneasiness.

Also, in the mobile terminal device set forth in Patent Literature 1, the user can issue the information to the appointed person only when such user uses the moving unit an operating schedule of which is known previously. For example, the information to the effect that the user is late for the appointment cannot be issued during when the user is moving by a car or a bicycle. Also, when the user of the mobile terminal device is late for the appointment at user's convenience (the user left home late, the user stopped over at a way station, or the like), the user must set the information such as the boarding station the passenger train, the riding time, etc. once again. Such operations are troublesome. In addition, the user cannot apply the above mobile terminal device to the passenger vehicle, the arrival time of which does not match exactly with the operating schedule, like the bus the running of which is delayed ordinarily.

The present invention has been made in view of the above circumstances, and it is an object of the present invention to provide a mobile terminal device capable of informing the other person being going to meet to the possessor by appointment of the information that the possessor will be late for an appointment, irrespective of the possessor's situation.

### DISCLOSURE OF THE INVENTION

A mobile terminal device of the present invention provides a mobile terminal device having a position sensing function, comprising:

a recording unit that records information regarding an appointed time, an appointed place, and an appointed person; and

a controlling unit that controls to send information indicating that a user is late for an appointment to the appointed person when position information sensed by the position sensing function at the appointed time does not match with the information of the appointed place.

According to this configuration, in the case where position information of the mobile terminal device sensed at an appointed time does not match with the information about the appointed place in comparison, in order to transmit the information indicating that the possessor is late for the appointment to the appointed person, the possessor of the mobile terminal device can inform the appointed person of the information that the possessor will be late for the appointment, irrespective of the possessor's situation.

Also, in the mobile terminal device of the present invention, the information indicating that the user is late for the appointment contains information of user's present position sensed by the position sensing function. The controlling unit controls to send repeatedly the information indicating that the user is late for the appointment.

According to this configuration, since the appointed person can check sequentially the position of the possessor of the mobile terminal device, he or she can use his or her time effectively until the possessor of the mobile terminal device arrives at the appointed place.

### BRIEF DESCRIPTION OF THE DRAWINGS

FIG. 1 is a block diagram showing an example of a configuration of a mobile terminal device according to an embodiment of the present invention;

FIG. 2 is a configurative view showing an example of an appointment information communicating system including the mobile terminal device according to the embodiment of the present invention;

FIG. 3 is a flowchart showing an example of appointment data inputs in the mobile terminal device according to the embodiment of the present invention;

FIG. 4 is an explanatory view showing an example of a display screen of the mobile terminal device according to the embodiment of the present invention;

FIG. 5 is an explanatory view showing an example of a display screen of the mobile terminal device according to the embodiment of the present invention;

FIG. 6 is a flowchart showing an example of a processing operation in the mobile terminal device according to the embodiment of the present invention; and

FIG. 7 is an explanatory view showing an example of a display screen of the mobile terminal device according to the embodiment of the present invention.

In Figures, a reference numeral 1 is a position sense portion, 2 a communication portion, 3 a clock portion, 4 an input portion, 5 a display portion, 6 a control portion, 7 a CPU, 8 a RAM, 9 a ROM, and 10 a configuration save memory.

### BEST MODE FOR CARRYING OUT THE INVENTION

An embodiment of the present invention will be explained with reference to the drawings hereinafter.

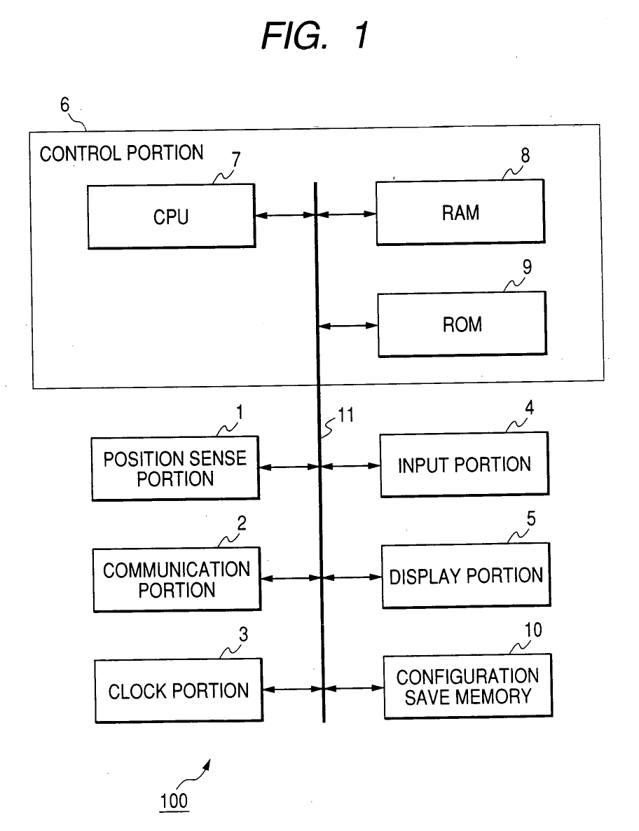

FIG. 1 is a block diagram showing an example of a schematic configuration of a mobile terminal device 100 according to an embodiment of the present invention. The mobile terminal device 100 of the present embodiment includes a position sense portion 1 composed of the GPS receiver for receiving a signal of the GPS satellite to measure the position, or the like, a communication portion 2 for transmitting/receiving a sound signal and the E-mail, a clock portion 3 for measuring a current time, an input portion 4 composed of a key-pad, or the like, a display portion 5 composed of a liquid crystal display device, or the like, a control portion 6 consisting of a CPU (Central Processing Unit) 7, a RAM (Random Access Memory) 8, a ROM (Read Only Memory) 9, and the like, and a configuration save memory 10 for saving a configuration that the possessor of the mobile terminal device 100 sets. Respective portions are connected via a bus line 11.

The CPU 7 controls the overall mobile terminal device 100 in accordance with the program stored in the ROM 9, while using the RAM 8 as a working memory. Also, the RAM 8 provides a memory area that develops the data to the CPU 7, and stores temporarily map data downloaded via the Internet, and the like therein.

The programs executed by the CPU 7 and the mail transmitting/receiving program are stored in the ROM 9. Also, the GPS monitoring program used to receive the radio wave from the GPS satellite and measure user's present position, the map displaying program used to display a map on the display portion 5, and the like are stored in the ROM 9.

In addition, for example, the address management program for managing E-mail addresses, phone numbers, etc. in answer to names of the appointed persons, the Internet browser program connected to the Internet to search Internet contents, the address translating program for translating the latitude/longitude input as the appointed place into the address, and the like are stored in the ROM 9.

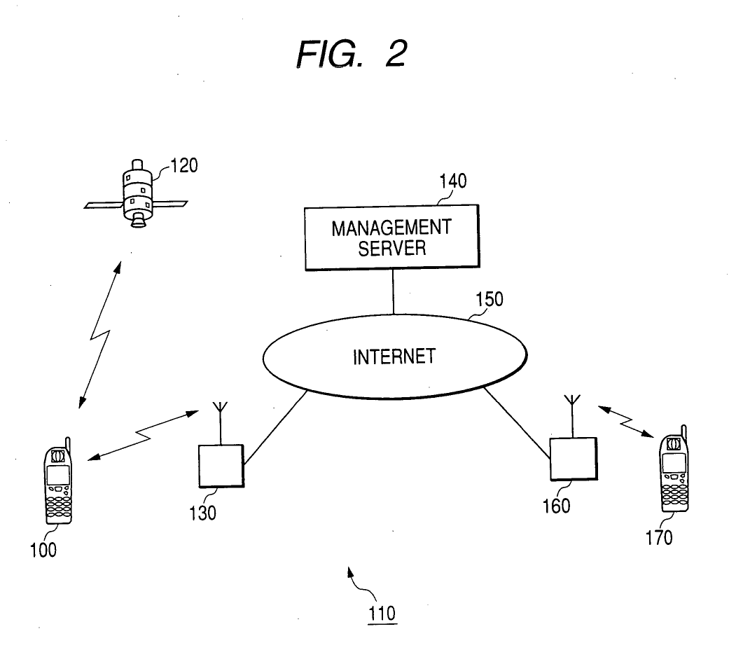

FIG. 2 is a schematic view showing an example of an appointment information communicating system 110 constructed to include the mobile terminal device 100 according to the embodiment of the present invention. This appointment information communicating system 110 is constructed by the mobile terminal device 100 for acting as the sender of appointed information, a mobile terminal device 170 possessed by the appointed person as the destination of the appointed information, a GPS satellite 120 for transmitting the data concerning user's present position of the mobile terminal device 100 to the mobile terminal device 100, an access point 130 for receiving the information from the mobile terminal device 100, an access point 160 for transmitting the information to the mobile terminal device 170, a management server 140 for executing the transferring process of the appointment information from the mobile terminal device 100 to the mobile terminal device 170, and the like, and the Internet 150 to which the access point 130, the access point 160, and the management server 140 are connected.

In this case, the mobile terminal device 100 can measure exactly user's present position and the current time based on the data transmitted from the GPS satellite 120. But other systems for sensing user's present position, for example, the self-contained navigation system having a moving distance sensing function and a moving argument sensing function, the PHS (Personal Handy-phone System) position information system, etc. may be employed.

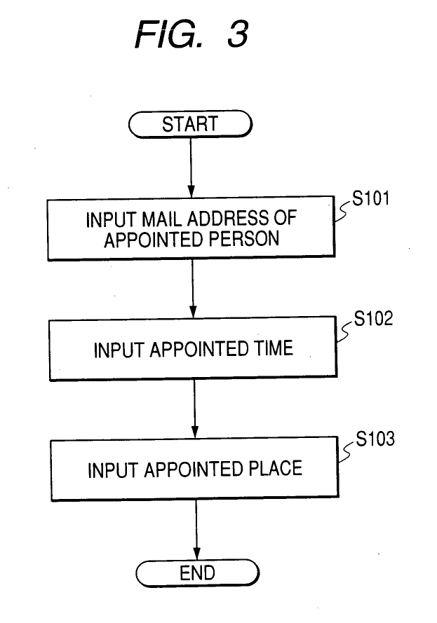

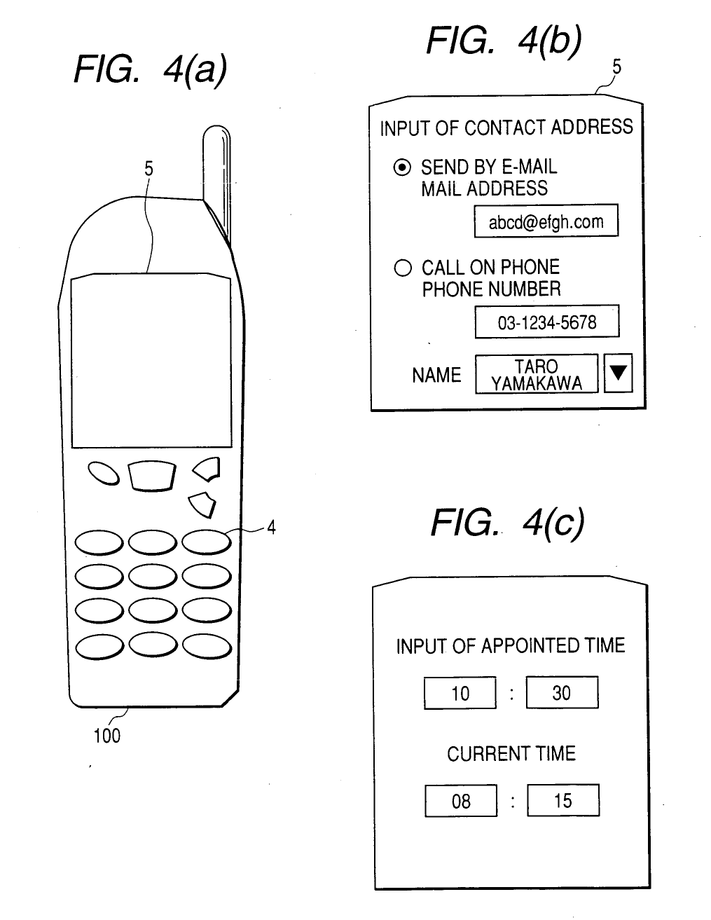

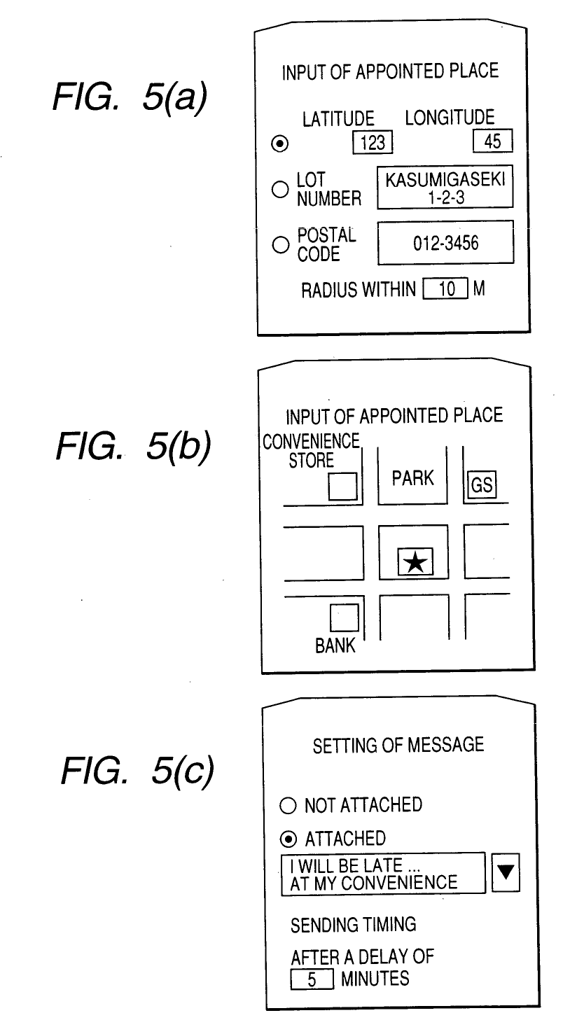

Then, operations of the mobile terminal device 100 and the appointment information communicating system 110 constructed as above will be explained hereunder. FIG. 3 is a flowchart showing an example when the mobile terminal device 100 in the embodiment of the present invention inputs the appointment data. Also, FIGS. 4 and 5 are explanatory views showing displayed contents in such case.

An operation executed in inputting the appointment data will be explained with reference to FIG. 3 hereunder. In step S101, the possessor of the mobile terminal device 100 inputs the destination, e.g., the mail address of the appointed person by using the input portion 4. As the method of inputting the mail address of the appointed person, there are the method of inputting directly the mail address by using the input portion 4, the method of displaying previously the mail address listed on the phone book on the display portion 5 and then selecting the desired mail address from the displayed mail addresses by operating the input portion 4, and the like.

FIG. 4(b) is an enlarged view of the display portion 5 of the mobile terminal device 100 shown in FIG. 4(a), and is an explanatory view showing an example of an input screen of the destination. On this screen, the user can choose either of the case where the user sends the information to the destination by the E-mail and the case where the user calls the destination on the phone, by using a radio button. When the user sends the information by the E-mail, such user inputs the mail address of the destination.

In case the address management program is being started on this screen, the input of the E-mail address or the phone number can be omitted if either the name of the appointed person is input into the name box or the previously registered name is selected from the list.

Then, in step S102, the appointed time is input by using the input portion 4. FIG. 4(c) is an explanatory view showing an example of the input screen of the appointed time. If the current time is displayed simultaneously on this screen, the appointed time can be input easily.

Then, in step S103, the appointed place is input by using the input portion 4. As the method of inputting the appointed place, there are the method of inputting directly the latitude and the longitude by using the input portion 4, the method of putting a mark on the map information acquired from the management server 140 via the communication portion 2 by operating the input portion 4, and the like.

FIGS. 5(a) and 5(b) are explanatory views showing an example of an input screen of the appointed place respectively. In FIG. 5(a), as the method of pointing the appointed place, the user may choose any one of the method of using the latitude and the longitude, the method of using the lot number, and the method of using the postal code by using a radio button. Also, if the user inputs 10 m, for example, into a radius box, the user can send the information to the effect that such user will late for the appointment when the user cannot arrive at a place within a radius 10 m of the appointed place.

Here, in case the address translating program is being started, the latitude and the longitude being input are translated to the lot number or the postal code and then input. Therefore, the input of the appointed place can be easily executed.

As the method of pointing the appointed place, FIG. 5(b) displays a black star mark indicating the appointed place on the map information. Since the map information can display simply and clearly the appointed place, the user can easily point the appointed place.

Also, in FIG. 5(c), the user can choose whether or not a message should be attached to the E-mail that is sent to the appointed person, by using a radio button. On this screen, the user can not only input the original message formed by the possessor of the mobile terminal device 100 but also choose the previously registered message “I will be late at my convenience”, or the like, for example, from the list. Further, on this screen, a timing at which the information indicating the effect that the user will be late for the appointment is issued to the appointed person can be set to a time after five minutes lapsed from the appointed time.

Various data including the information of the appointed person such as the E-mail address of the appointed person, etc. input in this manner and the information indicating the appointed time and the appointed place are held in the RAM 8 or the configuration save memory 10 as appointed data.

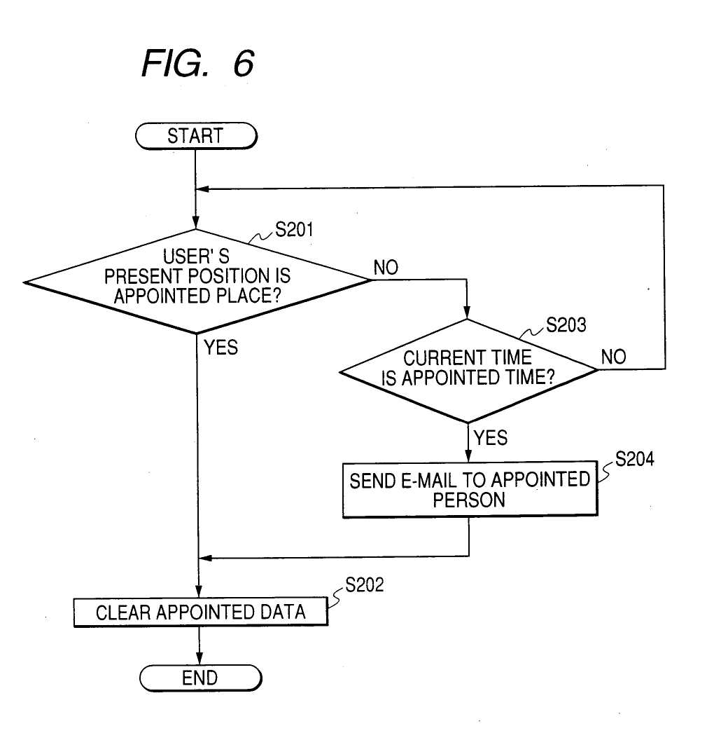

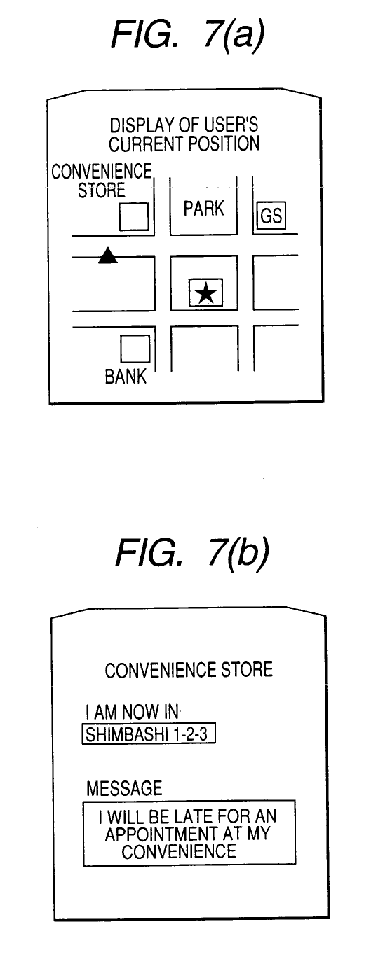

Next, a control operation in deciding whether or not the user is going to be late for the appointment will be explained hereunder. FIG. 6 is a flowchart showing an example of the control operation in deciding whether or not the user is going to be late for the appointment, and FIG. 7 is an explanatory view showing display contents sent to the appointed person.

In step S201 in FIG. 6, the control portion 6 compares user's present position information sensed by the position sense portion 1 with the appointed place in the appointed data. If user's present position matches with the appointed place or a distance between user's present position and the appointed place is within a radius input in FIG. 5(a) (S201: YES), the control portion 6 decides that the possessor of the mobile terminal device 100 arrives at the appointed place, and then the process goes to step S202. Then, the control portion 6 clears the appointed data, and the process is ended.

In contrast, if user's present position does not match with the appointed place or the distance between user's present position and the appointed place is longer than the radius input in FIG. 5(a) (S201: NO), the process goes to step S203. In step S203, the control portion 6 compares the current time measured by the clock portion 3 with the appointed time in the appointed data.

If the current time does not match with the appointed time (S203: NO), the process goes back to step S201 and then the process is repeated. If the current time matches with the appointed time (S203: YES), the process goes to step S204.

Since the process goes to step S204 only when the mobile terminal device 100 is not present in the appointed place at the appointed time, the information of the possessor of the mobile terminal device 100, e.g., the information of user's present position sensed by the position sense portion 1 are sent to the appointed person by the E-mail.

The control portion 6 controls the communication portion 2 to send the E-mail. Also, as the information of user's present position contained in the E-mail, the map information to which a mark indicating user's present position is attached, the message such as “I am now in xxx (xxx is the name of place)”, etc. may be considered.

FIGS. 7(a) and 7(b) are explanatory views showing an example of the display screen of user's present position respectively. In FIG. 7(a), a black triangular mark indicating user's present position of the possessor of the mobile terminal device 100 is displayed on the map information. Also, in FIG. 7(b), user's present position of the possessor of the mobile terminal device 100 is displayed by the lot number, and also the message “I will be late for an appointment at my convenience” is displayed. The process goes to step S202 after the sending of the E-mail, and control portion 6 clears the appointment data and ends the process.

As described above, according to the mobile terminal device 100 according to the embodiment of the present invention, when user's present position sensed by the position sense portion 1 does not match with the information of the appointed place and the current time matched with the appointed time, the control portion 6 sends the E-mail containing the information indicating that “the user will be late for the appointment” to the appointed person.

According to this configuration, when the possessor of the mobile terminal device 100 is late for the appointment, such possessor can inform automatically the appointed person of the information that the possessor will be late for the appointment. Therefore, even when the possessor of the mobile terminal device 100 does not become aware of the delay of the train or such possessor cannot operate the mobile terminal device 100 in the middle of driving the car, such possessor can inform automatically the appointed person of possessor's current situation not to cause the appointed person uneasiness.

In the above example, the case where the E-mail is sent only once when the user is late for the appointed time is explained. But the sending of the E-mail containing the information of user's present position may be repeated every predetermined period until the user arrives at the appointed place. If doing so, the E-mail is sent plural times every predetermined period when the user is late for the appointment. As a result, the appointed person who is waiting for the user at the appointed place can know in detail where the delayed user is now, and can utilize effectively a time until the user arrives at the appointed place.

Also, in the above example, the cellular phone device or the PHS system is shown as the mobile terminal device 100. But the mobile terminal device of the present invention can also be applied to the PDA (Personal Digital Assistant) having a radio communication function, the mobile PC (Personal Computer), and the like.

The present invention is explained in detail with reference to particular embodiment. But it is apparent for those skilled in the art that various variations and modifications can be applied without departing a spirit and a scope of the present invention.

The present application is based upon Japanese Patent Application No. 2003-104093, filed on Apr. 8, 2003, the contents of which are incorporated herein by reference.

### INDUSTRIAL APPLICABILITY

According to the present invention, the mobile terminal device capable of informing the appointed person of the effect that the possessor of the mobile terminal device will be late for the appointment, irrespective of the possessor's situation can be provided.

1. A mobile terminal device having a position sensing function, comprising:
a recording unit that records information regarding an appointed time, an appointed place, and an appointed person; and
a controlling unit that controls to send information indicating that a user is late for an appointment to the appointed person when position information sensed by the position sensing function at the appointed time does not match with the information of the appointed place.

2. The mobile terminal device according to claim 1, wherein the information indicating that the user is late for the appointment contains information of user's current position sensed by the position sensing function, and
wherein the controlling unit controls to send repeatedly the information indicating that the user is late for the appointment.
